(19) United States
(12) Patent Application Publication
(10) Pub. No.: US 2014/0316884 A1
(43) Pub. Date: Oct. 23, 2014

(54) INTERACTIVE ADVERTISING SYSTEM

(71) Applicant: YAHOO! INC., Sunnyvale, CA (US)

(72) Inventor: Viswanathan Munisamy, Chennai (IN)

(73) Assignee: Yahoo! Inc., Sunnyvale, CA (US)

(21) Appl. No.: 13/867,827

(22) Filed: Apr. 22, 2013

(51) Int. Cl. G06Q 30/02

(52) U.S. Cl. CPC G06Q 30/0251
USPC 705/14.49

(57) ABSTRACT

An electronic device implemented method may include presenting an advertisement via user interface of a first application, receiving an anticipated user input associated with the presented advertisement, and performing an action associated with the anticipated user input. The anticipated user input being a gesture and the action being at least an interaction with an advertiser or an agent of the advertiser associated with the advertisement. Alternatively or additionally, the action may be at least an interaction with a second application associated with the gesture.

### FIELD

Example embodiments relate to interactive advertising systems.

### BACKGROUND

Online advertising has become a mainstay of the advertising industry and has become important to doing business in today's technology driven economy. Online advertising may be found in various shapes and sizes, and may include audio and video content. Examples of online advertisements may include ads in search engine results, banner ads, rich media ads, social network advertising, interstitial ads, e-mail ads, and the like. A common theme in online advertising is that the displayed ads can be viewed and clicked on; and by clicking on an ad, an Internet browser may navigate to a website associated with the advertiser.

### BRIEF DESCRIPTION OF THE DRAWINGS

An interactive advertising system may be better understood with reference to the following drawings and description. Non-limiting and non-exhaustive examples are described with reference to the following drawings. The components in the drawings are not necessarily to scale, emphasis instead being placed upon illustrating the principles of the system. In the drawings, like referenced numerals designate corresponding parts throughout the different views.

FIG. 1 illustrates a block diagram of an example of a network that can implement one or more aspects of an interactive advertising system.

FIG. 2 illustrates a block diagram of an example of an electronic device that can implement one or more aspects of an interactive advertising system.

FIGS. 3 and 4 illustrate example gestures.

FIG. 5 illustrates a flowchart of example operations of one or more aspects of an interactive advertising system.

FIG. 6 illustrates another example flowchart of example operations of one or more aspects of an interactive advertising system.

### DETAILED DESCRIPTION

Described herein is an interactive advertising system. Such a system can be an entryway to interaction between advertisement audiences and advertisers. For example, online advertisements can be entry points to further communications between an advertiser and an online user. In one implementation, a user swiping to the left, over an online advertisement, may cause a device, e.g., a smart phone, to place a call to an associated advertiser. In another example, other functions of a mobile device may be used, e.g., GPS functions. For example, when the user swipes to the left, not only is the advertiser called, but the closest place of business of the advertiser is called. Also, swiping down could lead to sending a text to the advertiser and swiping to the right could lead to searching for information regarding the advertiser, e.g., searching for specials or other locations associated with the advertiser. In one example, a gesture directed at the advertisement may cause an Internet search for content related to or associated with the advertisement.

These functions can occur without leaving the application or web site hosting the ad. This may be especially useful in advertising in the mobile context. Additionally, target advertising may be combined with these gesture-to-action examples, and such services can be added to an advertising program. For example, fees can be associated with various levels of gesture-to-action functionality and combined target advertising.

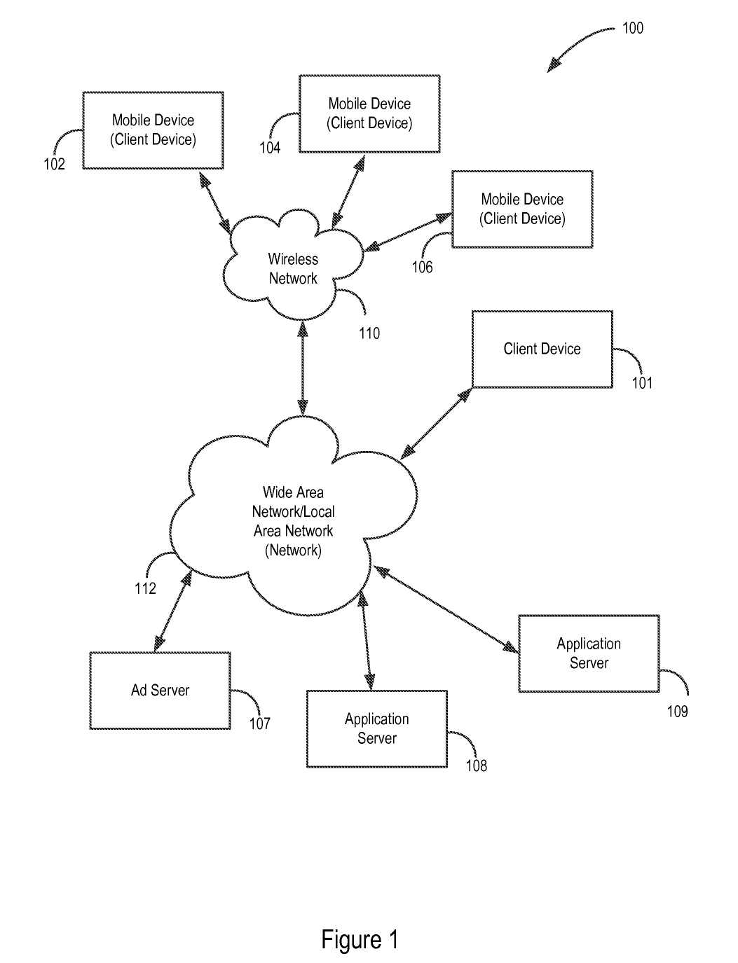

FIG. 1 illustrates a block diagram of an example of a network that can implement one or more aspects of an interactive advertising system. As shown in FIG. 1, for example, a network 100 may include a variety of networks, e.g., local area network (LAN)/wide area network (WAN) 112 and wireless network 110, a variety of client devices, e.g., client device 101 and mobile devices 102-106, and a variety of servers, e.g., application servers 108 and 109 (e.g., web, email, messaging, and/or search servers) and advertising server 107. A network, e.g., the network 100, may couple devices so that communications may be exchanged, e.g., between a server and a client device or other types of devices, including between wireless devices coupled via a wireless network, for example.

The application servers 108 and 109 can provide content and/or applications to a user. The user can view or use the content and/or applications from a client device, e.g., a mobile client device. Integrated with the content and/or applications, advertisements may be received from advertisement sources, e.g., advertisement servers.

Software, hardware, and/or firmware that provide gesture-to-action examples may be stored or embedded at a client device and/or a server, e.g., an application server or an advertisement server. Also, the source of the gesture-to-action examples may be communicated from one device to another. For example, software that may enable such functionality may be uploaded from a server to a client device.

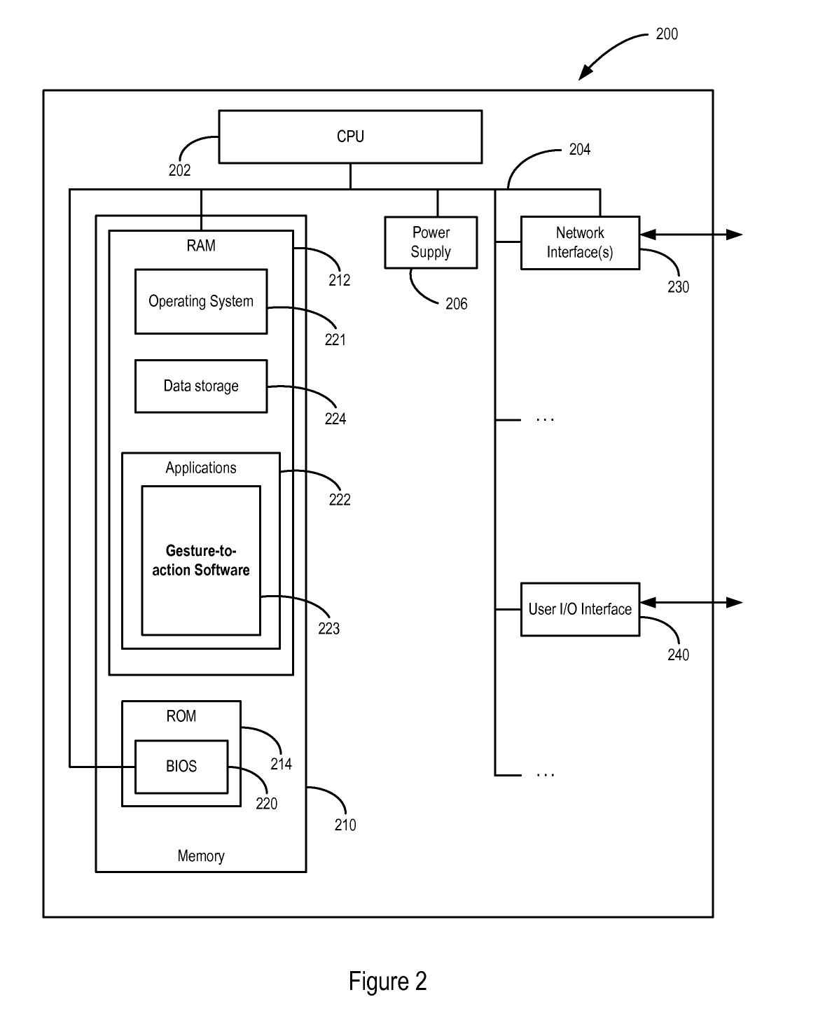

FIG. 2 illustrates a block diagram of an example of an electronic device that can implement one or more aspects of an interactive advertising system. Instances of the electronic device 200 may include one or more servers, e.g., servers 107-109, and client devices, e.g., client devices 101-106. A client device may be a desktop computer, a laptop computer, a tablet, or a smartphone, for example. In general, the electronic device 200 may include a processor 202, memory 210, a power supply 206, and input/output components, e.g., network interface(s) 230 and user input/output interface(s) 240. The user input/output interface(s) 230 may include an audio interface, a display, a key pad or keyboard, a touchscreen, and proximity sensors, for example. A communication bus 204 connects the aforementioned elements of the electronic device. The network interfaces 230 may include a receiver and a transmitter (or a transceiver), and an antenna for wireless communications. The processor 202 can be one or more of any type of processing device, e.g., a central processing unit (CPU). Also, for example, the processor 202 can be central processing logic; central processing logic may include hardware, firmware, software and/or combinations of each to perform a function(s) or an action(s), and/or to cause a function or action from another component. Also, based on a desired application or need, central processing logic may include a software controlled microprocessor, discrete logic e.g., an application specific integrated circuit (ASIC), a programmable/programmed logic device, memory device containing instructions, or the like, or combinational logic embodied in hardware. Also, logic may also be fully embodied as software. The memory 210, which may include RAM 212 or ROM 214, can be enabled by memory device, e.g., a primary (directly accessible by the CPU) and/or a secondary (indirectly accessible by the CPU) storage device (e.g., flash memory, magnetic disk, optical disk). The RAM may include an operating system 221, data storage 224, and applications 222, e.g., a software implementation of the gesture-to-action functionality 223. The ROM may include BIOS 220 of the electronic device 200. The power supply 206 contains one or more power components, and facilitates supply and management of power to the electronic device 200.

A client device may vary in terms of capabilities or features. Claimed subject matter is intended to cover a wide range of potential variations. For example, a cell phone example may include a numeric keypad or a display of limited functionality, e.g., a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, and/or a display with a high degree of functionality, e.g., a touch sensitive color 2D or 3D display, for example.

A client device may include or may execute a variety of possible applications, e.g., a client software application enabling communication with other devices, e.g., communicating one or more messages regarding operation or configuration of the gesture-to-action functionality. A client device may also include or execute an application to communicate content, e.g., textual content or multimedia content, related to the gesture-to-action functionality. A client device may also include or execute an application to perform a variety of possible tasks, e.g., browsing, searching, or analyzing forms of content related to or associated with the gesture-to-action functionality.

Where the electronic device 200 is a server, it may include a computing device that is capable of sending or receiving data, e.g., via a wired or wireless network, or may be capable of processing or storing data, e.g., in memory as physical memory states, and may, therefore, operate as a server. Particularly, the server may be an application server that may include a configuration to provide an application, such an application that includes gesture-to-action functionality, via a network to another device. Also, an application server may host a website that can provide a user interface for administration of gesture-to-action functions.

Further, an application server may provide a variety of services that include web services, third-party services, audio services, video services, email services, instant messaging (IM) services, short message service (SMS) services, multimedia messaging service (MMS) services, file transfer protocol (FTP) services, voice over IP (VOIP) services, calendaring services, photo services, or the like, all of which may work in conjunction with the gesture-to-action functionality. Examples of content provided by the mentioned applications, including content resulting from gesture-to-action examples, may include text, images, audio, video, or the like, which may be processed in the form of physical data, e.g., electrical data, or may be stored in memory, as physical states.

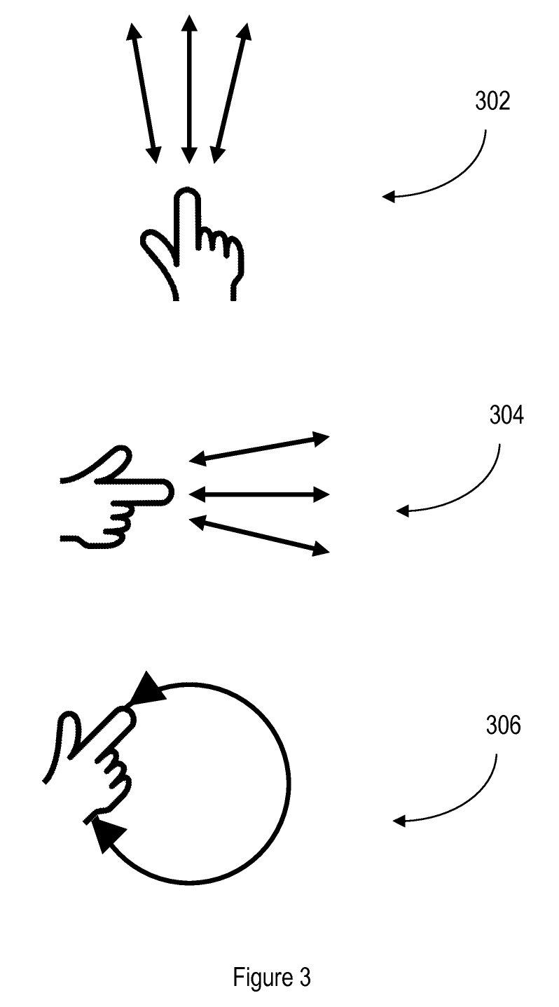

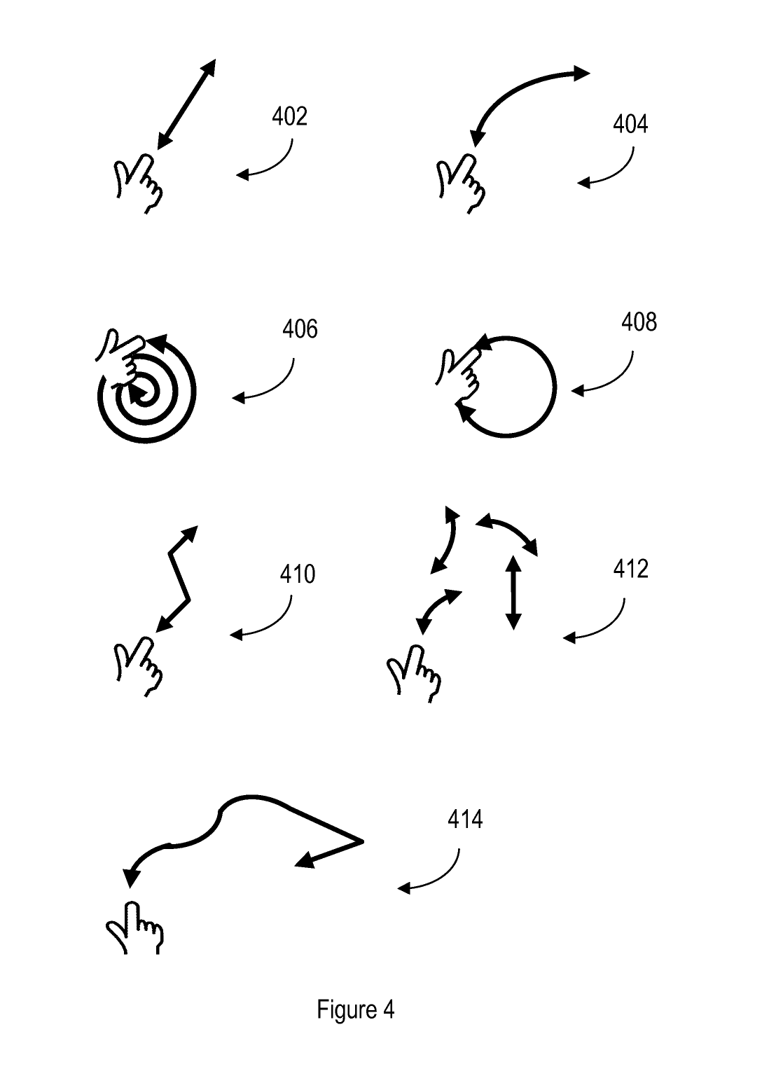

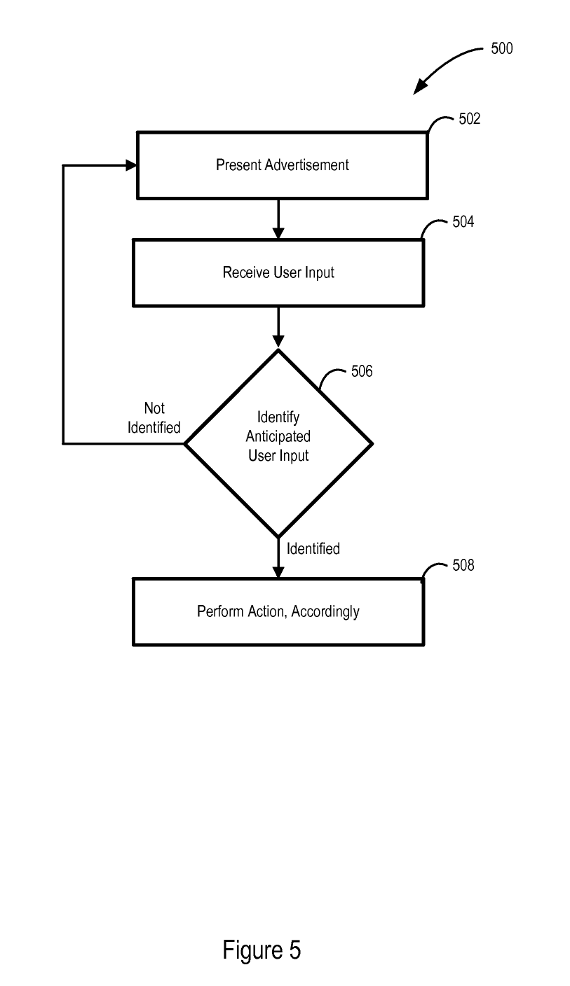

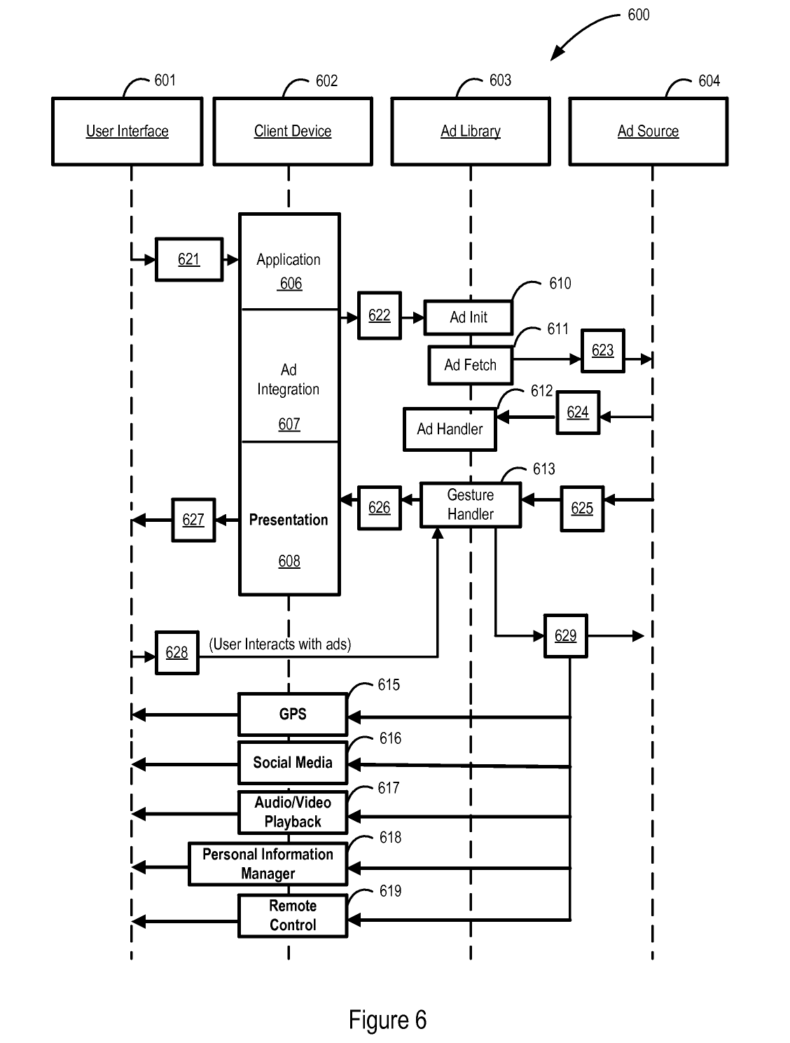

With respect to the gesture-to-action functionality, FIGS. 3 and 4 illustrate example gestures; and FIGS. 5 and 6 illustrate flowcharts of example operations of one or more aspects of interactive advertising systems utilizing the gesture-to-action examples.

Depicted in FIG. 3, gestures may include one or more vertical 302, horizontal 304, and/or circular motions 306, e.g., a straight and/or curved swipe over a touchscreen. Gestures may also be made by voice command or any type of tactile input, e.g., pressing certain keys of a keyboard or keypad. Some gestures may be designated universally across applications, and other gestures may be particular to certain applications. For example, a circular gesture may trigger initiating a phone call to an advertiser of a displayed advertisement in certain applications or situations, e.g., when the advertisement accompanies search results. Alternatively, a circular gesture in a video playback application may trigger an advertisement integrated with video content to be replayed, fast-forwarded, or rewound.

A swipe from left to right or right to left, e.g., depending on user configurations, may trigger a message application initiating a messenger prompted to message the advertiser. Gestures may also include a downward swipe from top to bottom of an ad resulting in the ad being switched or removed. Gestures may also include inputting an “@” symbol, via a keyboard or keypad or by motioning a finger near or over an advertisement, which may cause sending of an email to the advertiser with a determined message or opening of an editable and unsent email with an address of the advertiser included in a recipient field. Configurations may also be made so that motioning or inputting a “+” symbol may trigger adding the advertisement or an event associated with the advertisement to a calendar or a to-do list, e.g., a calendar or to-do list of a personal information manager. Also, a determined gesture may cause a social media application to post the advertisement or a link to the advertisement to a social media profile of the user or a contact of the user. For example, tapping an ad three times may trigger a “like” post on FACEBOOK regarding the advertiser or the advertisement.

Furthermore, gestures may include patterns of clicks and/or swipes over or proximate to an advertisement. Gestures may also be verbal or include other physical actions of a user, e.g., retinal movement, blinking of an eye, or lip movement, for example. Gestures may include touching a screen displaying an advertisement, motioning proximate to the screen without touching it, or a combination thereof. The variations of gestures imaginable are limitless. For example, gestures, e.g., hand or finger gestures, directed to a presented advertisement, e.g., gestures nearby and/or in contact with a user interface presenting the advertisement, may include straight 402, curved 404, spiral 406, circular 408, zigzagging 410, dispersed 412, continuous 414, forceful, and slight gestures, as depicted in FIG. 4. In an example, one or more forms of sign language can be used as a basis for the gestures.

As described, each gesture, whether expected or not, may cause a variety of actions and/or interactions with the advertiser, e.g., various audio or video renderings, various types of communications, e.g., text or voice communications, typical Internet functions, e.g., an Internet search or hyperlinking, and any combination thereof. The actions and/or interactions may include storing an image and/or video associated with the advertisement or advertiser. The actions and/or interactions may also include setting up any type of communication with a corresponding advertiser or another organization, business, or person. For example, the actions and/or interactions may include providing a blank or partially authored field for an email, online post (e.g., a social media post), text message, or voice message, for audio and/or visual presentation to the advertiser or another organization, business, or person. The actions and/or interactions may also include selecting and communicating a determined message to the advertiser or another organization, business, or person. The actions and/or interactions may also include initiating a phone call or audio or video chat with the advertiser or another organization, business, or person. The actions and/or interactions may also include providing navigation services, e.g., providing directions to a geographic location of the advertiser. The actions and/or interactions may also include instructing a remote control application to perform a function, e.g., changing an operating television to a television channel commonly showing advertisements of the advertiser. The actions and/or interactions may also include instructing an audio and/or video playback system to perform an action, e.g., playing content associated with or including other advertisements associated with the advertiser. The actions and/or interactions may also include adding a calendar, to-do list, or contacts entry into a personal information manager, which may be associated with the advertisement.

FIG. 5 illustrates a flowchart of example operations of one or more aspects of an interactive advertising system. For example, FIG. 5 illustrates a flowchart of an example method that can be performed by one or more aspects of an example device, e.g., the electronic device 200 (method 500). The one or more aspects of the example device, e.g., a display of the user input/output interface(s) 240, may present an advertisement via a user interface of a first application, at 502. The one or more aspects of the example device, e.g., a touchscreen of the user input/output interface(s) 240, may receive a user input associated with the presented advertisement, wherein the user input may include an anticipated gesture, e.g., one or more of any gestures illustrated in FIGS. 3 and 4, at 504. The one or more aspects of the example device, e.g., the processor 202, may identify the anticipated gesture, at 506. Where identified, the one or more aspects of the example device, e.g., the processor 202 along with other aspects, may perform an action associated with the identified gesture, at 508. The action may be at least an interaction with an advertiser or an agent of the advertiser associated with the advertisement or an interaction with a second application associated with the gesture. Where the anticipated gesture is not identified, the one or more aspects of the example device may continue to present the advertisement, at 502.

FIG. 6 illustrates another flowchart of example operations of one or more aspects of an interactive advertising system. For example, FIG. 6 illustrates a flowchart of an example method that can be performed by one or more aspects of an example device, e.g., the electronic device 200 (method 600). The method 600 may include an electronic device 602, e.g., a client device, running an application 606 and an ad integration part 607 of the application. The running application 606 may communicate with an advertising functionality library 603 to initiate, fetch, and/or handle an advertisement from an ad source 604, e.g., an ad server. The initiation, fetching, and handling may be managed by respective modules 610, 611, and 612. Also, included is a gesture handler 613 interacting with a presentation layer 608, e.g., an ad presentation layer, of the application 606. The user can interact with advertisements through the running application 606, via a user interface 601 that communicates with the gesture handler 613. The gesture handler 613 can direct subsequent actions, e.g., contacting the advertiser through a phone call, email, or text message, based on one or more gestures of the user, e.g., one or more of any gestures illustrated in FIGS. 3 and 4.

The application 606, may be, include, or be associated with a global positioning system (GPS) application, a social media application or any other type of user-generated content system, an audio and/or video playback application (e.g., a streaming multi-media player), a video game, a remote control application, a personal information manager (e.g., YAHOO! CALENDAR or MICROSOFT OUTLOOK), one or more parts of a creative suite of applications (e.g., a graphic design application or a photo editor), and/or one or more parts of a suite of business or academic applications (e.g., a word processor, spreadsheet, database management system, project management system, presentation application, or an electronic interactive course). The application may be stored remotely and/or locally with respect to the client device 602. For example, the application may be a web application and/or stored and/or ran from a cloud computing system.

The ad integration part 607, may be included, associated with, or communicatively coupled with the application 606 and/or the presentation layer 608. The ad integration part 607 may be stored locally and/or remotely with respect to the client device. For example, aspects of the ad integration part may be stored and hosted by a control server of an ad network, e.g., Yahoo! Publisher Network.

The client device 602 may include or be communicatively coupled with the user interface 601 and/or the advertising functionality library 603. The ad source 604, may include or be communicatively coupled with the advertising functionality library 603. The ad source 604 may be a server or a peer device of a peer-to-peer network. Also, the client device may be a peer device in a peer-to-peer network.

In an example, the interactive advertising system may include a processor (e.g., the processor 202) and memory (e.g., the memory 210) communicatively coupled to the processor. The memory may include system instructions (e.g., the software implementation of the gesture-to-action functionality 223). These instructions may be executable by the processor to receive, via a user interface (e.g., user input/output interface(s) 240), user input that activates an application (e.g., application 606). The user input may be anticipated or not anticipated by the application. The system instructions may also be executable to receive, via a communication interface (e.g., network interface(s) 230) communicatively coupled to the processor, an advertisement, based on an advertisement handler (e.g., ad handler 612), which can be stored in the memory. Also, the instructions may be executable to transmit the advertisement to a display device associated with the user interface, based on the advertisement handler, and receive, via the user interface, user input directed at the advertisement that may include a gesture. The gesture may or may not be anticipated by a gesture handler. Based on the gesture and/or the gesture handler (e.g., gesture handler 613), the instructions may be executed to perform an action. The action may be associated with a direct communication to an advertiser or agent of the advertiser associated with the advertisement, for example. Also, the gesture handler may be associated with the advertisement and/or the advertisement handler.

The system instructions may also be executable to initiate the advertisement handler and the gesture handler while the application is running. Also, they may be executable to generate the gesture handler. In an example, the advertisement communicated to the advertisement handler may be accompanied by instructions that may be executable by the processor to generate the gesture handler. The instructions that accompany the advertisement may include object classes and interfaces associated the gesture handler.

In an example, a processor (e.g., the processor 202) can perform the method 600 by executing processing device readable instructions encoded in memory (e.g., the memory 210). In such an example, the instructions encoded in memory may include a software, hardware, or firmware aspect of the gesture-to-action functionality.

At 621, the method 600 may include a receiving aspect of the electronic device 602 receiving user input. The user input may be for an aspect of the running application 606. For example, the user input may include activating a web browser and/or selecting a web page. The user input may also include entering a search query, e.g., an Internet search query. Where the application is a GPS application, the user input may include a search for a particular destination or one or more points of interest, for example. Where the application is a social network service, the user input may be a post to the user's and/or a friend's online profile or an advertiser's profile or page.

At 622, the ad integration part 607 initiates advertising functionality within the running application 606 by communicating with the advertising functionality library 603. The advertising functionality library 603 may be a library of instructions for retrieving and handling advertisements, e.g., a library of advertisement related object classes and interfaces. These classes and interfaces may be object oriented, for example. A class of the advertising functionality library 603 may include the ad initiation module 610. The ad initiation module 610 may generate or select an ad container and may associate the container with one or more gesture handlers. Also, in an example, each container or ad may be associated with a corresponding gesture handler. A class of the advertising functionality library 603 may also include the ad fetching module 611, which may be operable to fetch ads from an ad server, a peer device, and/or an advertising network, for example. Also, the library 603 may include classes and/or interfaces for or that include ad handlers and/or gesture handlers, e.g., the ad handler 612 and the gesture handler 613.

At 623, instructions from the advertising functionality library 603, e.g., instructions from an ad fetch module 611, may instruct a request for one or more advertisements from the ad source 604. Such a request may be for a particular advertisement or campaign, or may include criteria for selecting one or more advertisements. For example, the one or more advertisements may include subject matter related to the application, e.g., an advertisement for running shoes being related to a personal fitness application.

At 624, the ad handler module 612 of the advertising functionality library 603 receives and handles one or more advertisements communicated from the ad source 604. The ad handler module 612 may also receive and coordinate the communication of scripts or modules that enable interactive functionality associated with an ad, and may communicate with the ad fetching module 611 to enable the interactive functionality.

At 625, according to the ad, the ad handler 612 and/or data associated with the ad and/or ad handler, an ad gesture handler 613 may be created and/or added to the advertising functionality library 603. The source of the ad gesture handler 613 may be the ad source 604 and may be added to the advertising functionality library 603 during the running of the application 606. Additionally or alternatively, an ad gesture handler may be added at another time when an associated application is not running. Also, the ad gesture handler 613 may be added from an aspect of the application 606 and/or the operating system of the client device 602.

At 626, while the application 606 is running, the one or more advertisements may be communicated to the presentation layer 608. The presentation layer 608 may include a designated ad presentation layer operable to receive advertisements, e.g., associated advertisements. The presentation layer 608 or the designated layer may include parameters for placing advertisements, including temporal, regional, and/or coordinate parameters for placing advertisements. The parameters may also include identifications of hardware to output the advertisements, e.g., parameters directing output to a graphical user interface (GUI) presented on a display. The user can interact with an advertisement once the advertisement is communicated to and presented by the ad presentation layer at 627.

At 628, a user may interact with the advertisement, e.g., by gesturing proximate to and/or over the advertisement. In such an example, the advertisement may be displayed by a display aspect of the user interface 601. A gesture may be identified by sensors associated or in communication with the user interface 601 and/or the presentation layer 608. For example, proximity or motion sensors or capacitive sensors of a touchscreen may sense the gesture. Also, for example, the gesture may be identified by a signal processing intermediate, e.g., a signal processing aspect of the presentation layer 608 or an intermediate associated or in communication with the presentation layer. The gesture may also be identified directly by a processing aspect of the gesture handler 613.

In an example, a running application, e.g., the application 606, receives user interaction data associated with an advertisement as input, e.g., data representing a voice command or gesture associated with the advertisement. The data can then be communicated to a gesture handler associated with the advertisement. In such an example, the gesture handler may be located within an aspect of a client device, an intermediary device, or an ad source, e.g., a corresponding ad server.

At 629, the gesture handler 613, triggered by a communication representing a designated user interaction, acts according to instructions of the handler. In this example, the trigger may include receiving data representative of a determined gesture associated with an advertisement The instructions of the gesture handler 613 as well as other modules described herein may include hardware, firmware, and/or software instructions.

In an example, upon receiving a signal reflecting a downward swipe, the instructions may instruct a search engine to search for locations of one or more advertisers of the one or more advertisements. The locations may be identifiable via the ad source 604. In another example, the handler may interact with a navigation system, e.g., a GPS application 615 of the client device 602, so that directions to one of the advertiser's locations, e.g., an advertiser's store, from the user's current position can be communicated to the user via the user interface 601. This action resulting from the trigger and other such actions can be performed while the application 606 is running and the user is interacting with the application in the forefront of the user interface 601.

Additionally or alternatively, the gesture handler 613 may interact with a social media application 616, an audio and/or video playback application 617, a personal information manager 618, and/or a remote control application 619, as a result of the trigger at 629. The trigger at 629 can be one or more gestures, e.g., one or more of any gestures illustrated in FIGS. 3 and 4.

In one example, the system may be initiated with a home screen of an electronic device, e.g., a mobile device. The home screen may include a feed, e.g., a web feed or news feed. Content of the feed may cover at least a part of the home screen, e.g., the entire home screen, and may be cycled through so that the home screen continually displays new content. The feed may cycle through new content automatically on a periodic basis or as a result of an operating system event, e.g., activation of the home screen. The content of the feed may include social media content from a social media service, e.g., profile pictures, photos posted by contacts, links, blog updates, and status updates. The feed may also include content with advertising, e.g., brand images, photos or videos posted by advertisers, links to webpages associated with advertisers, news associated with brands or advertisers, and posts of product or service programs or specials.

Through the system, a user may interact with the content of the feed. For example, various gestures may allow a user to view an entire image of a feed where the image, at first, is too large to fit onto the home screen. In one instance, the user may long press an image to zoom out of the image and/or slowly gesture in a direction to move the image in that direction. The user may also gesture to interact with others, which may include interacting with an entity that posted the image. For example, double-tapping the image or pressing a determined area of the image may lead to a post associated with the image, e.g., a “like” post or a comment.

Besides interacting with a fed image, gestures may allow a user to interact with the home screen or other operations of the electronic device. For example, a swipe or another determined gesture to the right may swap the home screen for a screen of a last application used by the user. A swipe or another determined gesture to the left may open a messaging application. A swipe or another determined gesture upwards may open another type of application, e.g., a social networking application associated with the fed image.

There are various examples for providing and deriving the system described herein. It is therefore intended that the foregoing detailed description be regarded as illustrative rather than limiting, and that it be understood that forthcoming claims, and their equivalents, are intended to define the spirit and scope of this system.

We claim:

1. A system, comprising:
a processor; and
memory communicatively coupled to the processor, the memory including system instructions executable by the processor to:
receive, via a communication interface communicatively coupled to the processor, an advertisement, based on an advertisement handler stored in the memory;
transmit the advertisement to a display device associated with a user interface of an application, based on the advertisement handler;
receive, via the user interface, user input directed at the advertisement that includes a gesture; and
perform an action based on the gesture and a gesture handler stored in the memory, wherein the action is associated with a communication to an advertiser or an agent of the advertiser associated with the advertisement.

2. The system of claim 1, wherein the gesture handler is associated with one or more of the advertisement or the advertisement handler.

3. The system of claim 1, wherein the system instructions are further executable to generate the gesture handler.

4. The system of claim 1, wherein the advertisement is accompanied by instructions that are executable by the processor to generate the gesture handler.

5. The system of claim 4, wherein the instructions that accompany the advertisement include object classes and interfaces associated with the gesture handler.

6. The system of claim 1, wherein the advertisement includes subject matter related to the application.

7. An electronic device implemented method, comprising:
receiving, at a user interface, user input that activates an application via a processor;
receiving, at a presentation layer of the application, an advertisement, based on a first part of an advertising functionality library;
displaying, at a display associated with the user interface, the advertisement, based on the first part of the advertising functionality library;
receiving, at the user interface, user input directed at the advertisement, the user input directed at the advertisement including a gesture; and
performing an action, by the processor, based on the gesture and on a second part of the advertising functionality library.

8. The method of claim 7, wherein the action includes setting up a communication to an advertiser or an agent of the advertiser associated with the advertisement.

9. The method of claim 7, wherein the advertising functionality library is stored within memory of the electronic device.

10. The method of claim 7, wherein the advertising functionality library is stored at a server communicatively coupled with the electronic device over a network.

11. The method of claim 7, wherein the advertising functionality library comprises object classes and interfaces.

12. The method of claim 7, wherein the advertisement includes subject matter related to the activated application.

13. An electronic device implemented method, comprising:
presenting an advertisement via a user interface of a first application;
receiving a user input associated with the presented advertisement, the user input including an anticipated gesture; and
performing an action associated with the anticipated gesture, the action being at least an interaction with an advertiser or an agent of the advertiser associated with the advertisement or an interaction with a second application associated with the gesture.

14. The method of claim 13, wherein the action includes providing a blank or partially authored field of an email, online post, text message, or voice message.

15. The method of claim 13, wherein the action includes selecting and communicating a determined message to the advertiser or the agent of the advertiser.

16. The method of claim 13, wherein the action includes initiating a phone call or audio or video chat with the advertiser or the agent of the advertiser.

17. The method of claim 13, wherein the action includes providing directions to a geographic location of the advertiser or the agent of the advertiser nearby the electronic device.

18. The method of claim 13, wherein the action includes instructing a remote control application to control another device.

19. The method of claim 13, wherein the action includes instructing an audio/video playback system to present at least one other advertisement associated with the advertiser.

20. The method of claim 13, wherein the action includes adding one or more of a calendar, a to-do list, or a contacts entry associated with the advertisement into a personal information manager.
